(19) United States
(12) Patent Application Publication
(10) Pub. No.: US 2011/0284348 A1
(43) Pub. Date: Nov. 24, 2011

(54) KEY INPUT DEVICE AND MOBILE TERMINAL DEVICE

(75) Inventor: Hideki NOHECHI, Saitama (JP)

(73) Assignee: SONY ERICSSON MOBILE COMMUNICATIONS AB, Lund (SE)

(21) Appl. No.: 12/974,500

(22) Filed: Dec. 21, 2010

Related U.S. Application Data
(60) Provisional application No. 61/347,197, filed on May 21, 2010.

(51) Int. Cl. H01H 9/26

(52) U.S. Cl. 200/50.36

(57) ABSTRACT

A key input device including a keyboard which includes a plurality of key switches including at least two adjacent key switches, and a stopper disposed between the two adjacent key switches and configured to inhibit one of the at least two adjacent key switches from receiving a pressing force when the other of the at least two adjacent key switches is pressed by a user.

### CROSS REFERENCE TO RELATED APPLICATIONS

This application is related to and claims priority under 35 U.S.C. §119(e) to Provisional Application Ser. No. 61/347,197, filed May 21, 2010, the contents of which are hereby incorporated herein by reference.

### BACKGROUND

1. Field

The present specification relates to a mobile terminal device, and, particularly, to a key input device of the mobile terminal device.

2. Description of the Related Art

A cellular phone unit, which is a typical example of a mobile terminal device, is formed into a multifunction unit. Therefore, not only does it allow speaking on a telephone and provide an electronic mail function, but it also provides enhanced functions involving text chatting and browsing, and inputting of characters to, for example, a memo pad or a schedule book. However, a keypad including number sequence keys (that is, a numeric keypad) that is frequently used in a related cellular phone device is thought to be unfit for inputting long sentences and inputting text messages that are continuously provided in real time, such as when chatting.

Accordingly, in recent years, the following type of cellular phone device which includes upper and lower housings, which slide with respect to each other, is provided. This type of cellular phone device uses a QWERTY keyboard (used often in a key input operation of a personal computer (PC) in place of number sequence keys). In this structure, in a normal state, the QWERTY keyboard is hidden in a housing section provided with a display screen, and is often exposed by sliding it when it is used. Using the QWERTY keyboard, a user can perform a key entry operation with his/her thumb while holding a terminal with both hands.

Japanese Unexamined Patent Application Publication No. 2009-278411 discusses a mobile device that can be used by slidably moving out a full keyboard placed behind a display section housing.

In particular, in a mobile terminal device to be reduced in size and weight, a structure in which a lower housing including a full keyboard is moved under and moved out from under an upper housing including a display unit by sliding the lower housing is desirably one in which a key height is as small as possible, that is, the thickness of a key input device is small.

On the other hand, there is a demand for providing a good key operability (operational feeling) and for reducing the probability of an occurrence of an operation error, while maintaining a structural strength of the key input device.

Therefore, it is desirable that, even for a small mobile terminal device having small individual key top sizes and having a plurality of keys that are disposed close to each other, a key input device providing good key operability and allowing few operation errors be provided. In addition, it is desirable that the portable terminal device using the key input device be provided.

### BRIEF SUMMARY

According to an embodiment, there is provided a key input device including a keyboard which includes a plurality of key switches including at least two adjacent key switches, and a stopper disposed between the two adjacent key switches and configured to inhibit one of the at least two adjacent key switches from receiving a pressing force when the other of the at least two adjacent key switches is pressed by a user.

According to another embodiment, there is provided a mobile terminal device including a display unit; and a key input device, wherein the key input device includes a keyboard which includes a plurality of key switches including at least two adjacent key switches, and a stopper disposed between the two adjacent key switches and configured to inhibit one of the at least two adjacent key switches from receiving a pressing force when the other of the at least two adjacent key switches is pressed by a user.

### BRIEF DESCRIPTION OF THE DRAWINGS

FIG. 1 is an external perspective view of a mobile terminal device according to an embodiment;

FIG. 2 is an exploded perspective schematic view of the structure of a key input device of the mobile terminal device shown in FIG. 1;

FIG. 3A is a plan view and FIGS. 3B and 3C are sectional views of the structure of a key sheet of the key input device shown in FIG. 2;

FIG. 4 is an exploded sectional view along a line IV-IV, in which a portion of the key input device shown in FIG. 3A is cut away;

FIG. 5 is an enlarged sectional view of a combination of a key dome and a protrusion on a dome sheet shown in FIG. 4;

FIG. 6 is a partially cutaway sectional view of the key input device in which a plurality of elements shown in exploded view in FIG. 4 are integrated to each other;

FIG. 7 is a sectional view showing a state in which one key top corresponding to a portion of the sectional view of FIG. 6 is pressed;

FIG. 8 is a plan view showing a state in which key domes and the dome sheet, and LEDs are mounted on a PCB in a lower housing in the embodiment;

FIG. 9 is a top plan view of a light-guiding sheet having a light-shielding sheet in the embodiment;

FIG. 10 is a plan view showing a state in which the light-guiding sheet having the light-shielding sheet is mounted by placing it upon the dome sheet at the lower housing in the state shown in FIG. 8;

FIGS. 11A and 11B are back views of the light-shielding sheet placed upon and adhered to a portion of the dome sheet;

FIGS. 11C and 11D show results of measurements of distributions of brightnesses at an upper surface of the light-guiding sheet having the light-shielding sheet for the cases shown in FIGS. 11A and 11B;

FIG. 12 is a plan view showing a state when the key input device is illuminated in a case where the light-shielding sheet having a white back surface is used;

FIG. 13 shows an example in which key tops are not aligned in a vertical direction (or a horizontal direction); and

FIG. 14 shows another example in which the key tops are not aligned in the vertical direction (or the horizontal direction).

### DETAILED DESCRIPTION

Preferred embodiments will hereunder be described in detail with reference to the attached drawings.

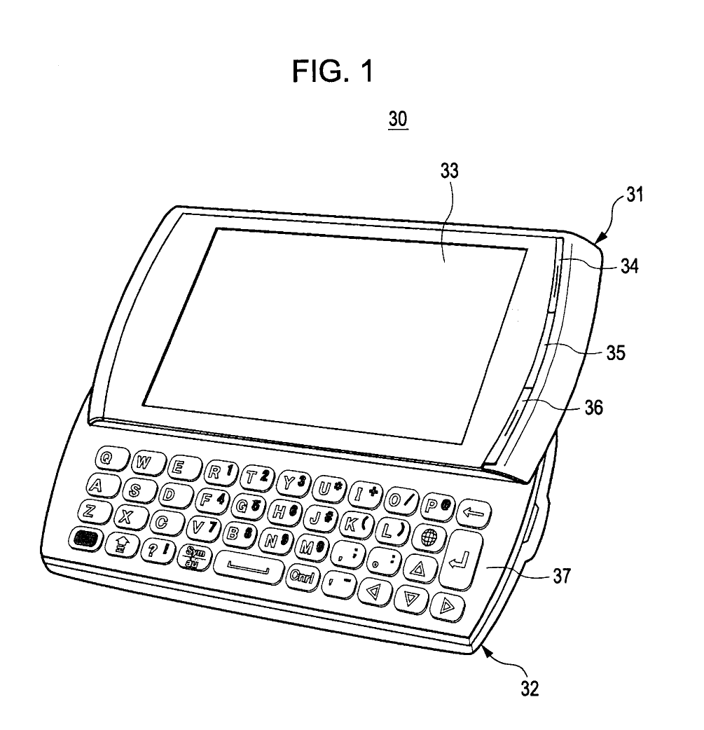

FIG. 1 is an external perspective view of a mobile terminal device 30 according to an embodiment. The mobile terminal device 30 includes an upper housing 31 and a lower housing 32. The lower housing 32 is connected to the upper housing 31 so that it can be moved under and moved out from under the upper housing 31 by sliding it.

The upper housing 31 includes a display unit 33 and hardware keys 34, 35, and 36. The display unit 33 has a screen that extends along substantially an entire area of the upper surface of the upper housing 31. The display unit 33 may have a touch panel used for detecting a touching action of a user on the screen. The hardware keys 34, 35, and 36 are disposed along an edge of one of longitudinal end portions of the upper housing 31.

The lower housing 32 includes a key input device 37 having a full key board disposed on its front surface. A plurality of keys (key tops) of the full key board are disposed in rows. The structure of the interior of the key input device 37 will be described in detail below.

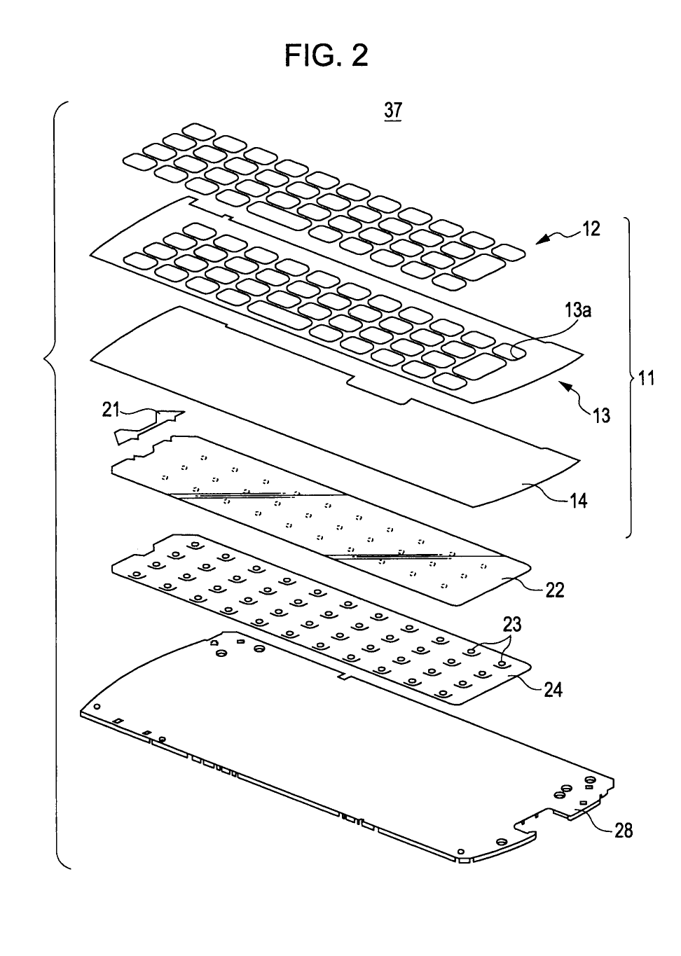

FIG. 2 is an exploded perspective schematic view of the structure of the key input device 37. The key input device 37 includes the plurality of key tops 12, a top cover 13, a resilient sheet 14, a light-shielding sheet 21, a light-guiding sheet 22, a dome sheet 24, and a printed circuit board (PCB) 28.

The plurality of key tops 12 constitute keys that are pressed by a user. Each key top 12 has a substantially square shape, is formed of, for example, synthetic resin (such as polycarbonate), and is rigid. Characters allotted to the keys are recorded (printed) on the front surfaces of the respective key tops 12. Portions where the characters are printed are provided so as to transmit light to the front surfaces from the back surfaces of key tops 12. In contrast, portions other than where the characters of the key tops 12 are printed are formed so as not to transmit light. In the embodiment shown in FIG. 2, main characters that are allotted to the respective key tops, and sub-characters that are allotted to some of the key tops and selected by a shift key are distinguished from each other by color. In the embodiment, the main characters are displayed in white, whereas the sub-characters are displayed in blue. Areas other than where the characters of the key tops are printed are black. In the embodiment, the smallest key top has a size that is 4.5 mm (vertical direction)×6.5 mm (horizontal direction).

The top cover 13 is a cover member extending along an entire area of the key input device 37 and having a plurality of openings 13a from which the top portions of the key tops 12 are exposed. The top cover 13 is formed of, for example, synthetic resin (such as polyethylene terephthalate (PET)). In the embodiment, the top cover 13 has a thickness of 0.188 mm, and is flexible to a certain extent, but is not elastic.

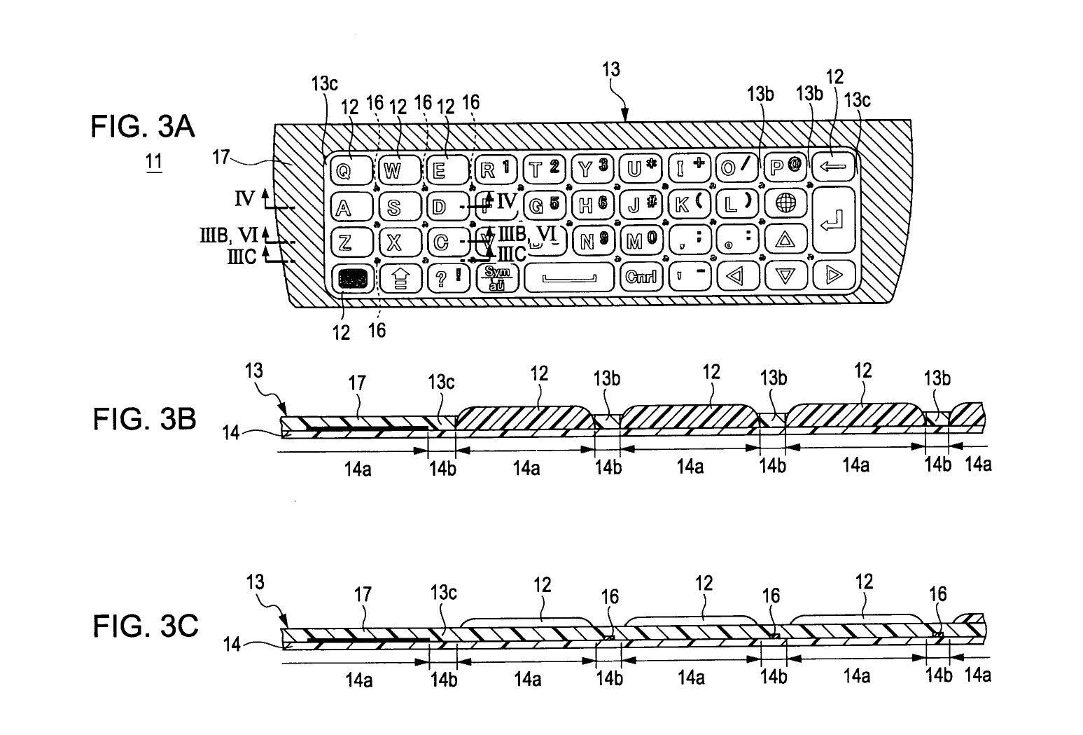

The top cover 13 and the plurality of key tops 12 are fixedly disposed on the resilient sheet 14 while the plurality of key tops 12 are exposed from the respective openings 13a of the top cover 13, and constitute a key sheet 11 (described later). A specific structure of the key sheet 11 will be described later with reference to FIGS. 3A to 3C.

The resilient sheet 14 is not only flexible, but is also elastic. In the embodiment, a urethane sheet member is used as the resilient sheet 14. The thickness of the resilient sheet 14 is 0.05 mm. Matt printing is performed on the back surface of the resilient sheet 14. In the embodiment, white ink mixed with a related matt material is used. The matt printing is performed to prevent unexpected noise from being generated when the back surface of the resilient sheet 14 sticks to the front surface of the light-guiding sheet 22, and both of the sheets are mounted or removed during a key operation.

By making the color of matt printing ink white, it is possible to diffuse light from a light-emitting element (which is a light source for key illumination (described later)) at the back surface of the resilient sheet 14. Since the resilient sheet 14 is considerably thin, the light transmitted through the resilient sheet 14 during the key illumination is not prevented from exiting upward from the character printed portions of the key tops 12 and from around the key tops 12.

The light-shielding sheet 21 is a member that covers the light-emitting element, and has a thickness of 0.04 mm. The front surface of the light-shielding sheet 21 is black, and the back surface of the light-shielding sheet 21 is white. Specific functions thereof will be described later.

The light-guiding sheet 22 is a transparent light guide that guides the light from the light-emitting element to each key position. In the embodiment, the light-guiding sheet 22 is formed using a urethane sheet member having a thickness of 0.2 mm.

The dome sheet 24 is a contact cover sheet at which dome contacts (serving as movable contacts) are positioned and covered at positions of the back surface of the dome sheet 24 corresponding to those of fixed contacts (described later).

The printed circuit board (PCB) 28 is a substrate having a circuit pattern (not shown) including the fixed contacts (such as a ring conductor member and a circular conductor member disposed in the ring) that are selectively set in electrical conduction by operating the plurality of dome contacts in accordance with respective pressing operations of the plurality of key tops 12. The fixed contacts and the respective movable contacts are disposed so as to oppose each other, and constitute a plurality of key switches that are operated in accordance with the pressing operations of the respective key tops.

The structure of the key sheet 11 will be described with reference to FIGS. 3A to 3C. FIG. 3A is a plan view of the structure of the key sheet of the key input device shown in FIG. 2. FIGS. 3B and 3C are sectional views of two locations in the structure of the key sheet. The scale of FIGS. 3B and 3C is such that FIGS. 3B and 3C are larger than FIG. 3A.

The key tops 12 and the top cover 13 are adhered to the front surface of the resilient sheet 14 as described above. However, not all of the back surface of the top cover 13 is adhered to the resilient sheet 14. Only a shaded portion shown in FIG. 3A is adhered to the resilient sheet 14. In the illustrated embodiment, excluding at least areas 13b where four sides of the respective key tops 12 oppose each other (that is, areas interposed between opposing sides of the key tops that are adjacent to each other), the top cover 13 is adhered to the resilient sheet 14. (In FIG. 3A, the resilient sheet 14 is hidden behind the key tops 12 and the top cover 13.

More specifically, the top cover 13 is adhered to the resilient sheet 14 at an area 17 (situated at the outer side of areas where the key tops 12 are disposed in rows), and at spot areas 16 (situated at substantially center portions of areas where corners of four keys adjacent to each other in the areas where the key tops 12 are disposed in rows oppose each other). In the embodiment, the spot areas 16 are circular. However, the shapes of the spot areas 16 are not limited to circular shapes. There also still remains non-adhesion areas 13c along the area 17 and at the outer sides of the outermost key tops 12 in the areas where the key tops 12 are disposed in rows. The areas 13b and 13c are approximately 1 mm wide.

In the embodiment, in the method of adhering the key tops 12 and the top cover 13 to the resilient sheet 14, a method of welding by heating is carried out. However, other types of methods may also be carried out. In order not to adversely affect the welding of the spot areas 16, it is possible not to perform the aforementioned matt printing on these areas.

FIGS. 3B and 3C are sectional views at lines IIIB-IIIB and IIIC-IIIC in FIG. 3A. In FIGS. 3B and 3C, ranges 14a represent adhesion areas on the lines, and ranges 14b represent non-adhesion areas on the lines. In FIGS. 3B and 3C, for convenience, each thick black line at a boundary of the top cover 13 and the resilient sheet 14 represents an adhesion portion.

In this way, the key sheet 11 has a structure in which not all of the surface of the top cover 13 is adhered to the resilient sheet 14, that is, non-adhesion areas are provided. That is, the peripheral areas along the four sides of the respective key tops 12 are non-adhesion areas excluding the spot areas 16 at the four corners of the respective key tops 12. In the specification, for convenience, such a structure in which a portion of the top cover 13 is adhered to the resilient sheet 14 will be called “partial adhesion structure.”

The inventor et al. of the application realized that, when the whole surface of the top cover 13 is adhered to the resilient sheet 14, key operability is hindered. This is thought to be because the resiliency of the resilient sheet 14 is no longer effectively used.

In contrast, by using the partial adhesion structure described above, the resiliency of the resilient sheet 14 at the peripheral areas along the four sides of the key tops 12 is maintained. Therefore, regardless of the structure being one in which the key tops 12 and the top cover 13 cover substantially the entire area of the key sheet 11, the flexibility of the key sheet 11 is increased. As a result, a good key operational feeling is obtained. Not all of the surface of the top cover 13 is adhered. However, the entire peripheral area 17 and the spot areas scattered at main portions of areas situated inwardly of the peripheral area 17 are adhered. Therefore, no problems areas in terms of mechanical strength of the key sheet 11 and, thus, the key input device. Specific operations of the partial adhesion structure will be described later.

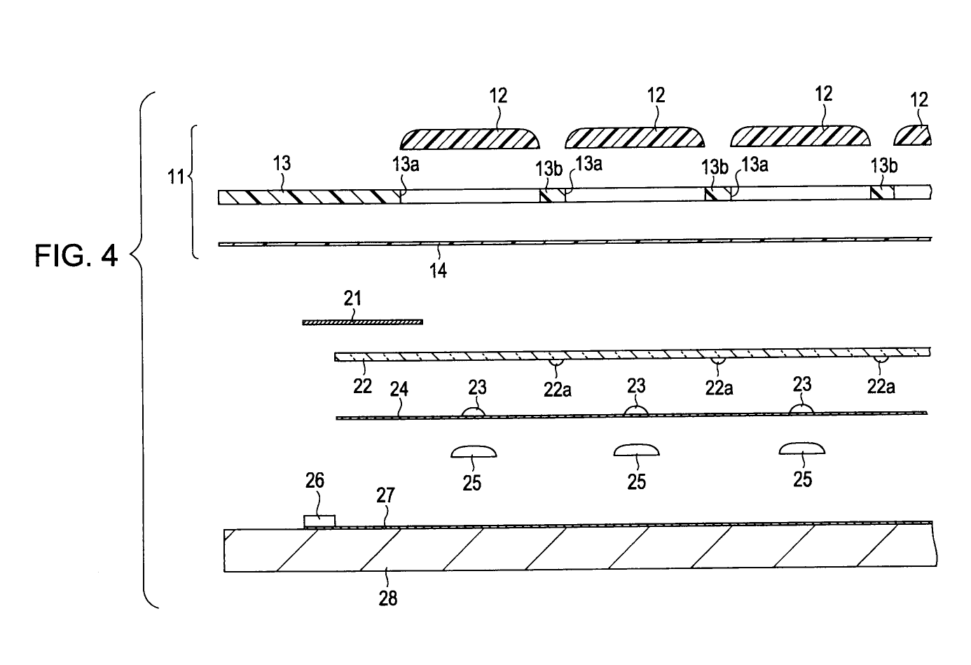

FIG. 4 is an exploded sectional view along a line IV-IV, in which a portion of the key input device 37 shown in FIG. 3A is cut away.

Some of the key tops 12, the top cover 13, the resilient sheet 14, the light-shielding sheet 21, the light-guiding sheet 22, the dome sheet 24, some of the key domes 25, and the PCB 28 are shown in exploded view in the vertical direction while they are aligned in the horizontal direction thereof. The key domes 25 are conductive dome-shaped members (such as metallic members) constituting the respective movable contacts of the key switches, and are elastic and restorable against pressing operations from thereabove. The external shapes of the top surfaces of the key domes 25 are circular shapes or rectangular shapes having rounded corners. The key domes 25 corresponding to the key tops 12 are covered by the dome sheet 24 illustrated in FIG. 2. Protrusions 23 are provided at surfaces at positions corresponding to the key domes 25 for the dome sheet 24. A planar size of each protrusion 23 as viewed from thereabove is smaller than a planar size of each key dome 25. Although the shape of each protrusion 23 is not particularly limited, it is, for example, substantially hemispherical or columnar. Each protrusion 23 functions as an actuator member for reliably driving its corresponding key dome 25 by pressing the corresponding key top 12 as a result of transferring the pressing of the corresponding key top 12 to the corresponding movable contact.

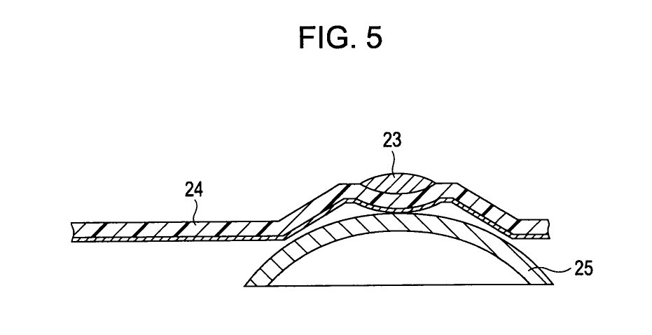

FIG. 5 is an enlarged sectional view of a combination of a key dome 25 and a protrusion 23 on the dome sheet 24. The dome sheet 24 has an adhesive layer at its lower surface. The adhesive layer 24 is adhered to the front surface of the key dome 25 and the PCB 28.

Returning to FIG. 4, a circuit pattern 27 including LEDs 26 (two LEDs 26 in the embodiment), serving as light-emitting elements, and the fixed contacts corresponding to the respective keys is disposed on the PCB 28. Protrusions (or posts) 22a corresponding to the aforementioned spot areas 16 are provided at the lower surface of the light-guiding sheet 22. Although the material of each protrusion 22a is not particularly limited, each protrusion 22a may be formed of, for example, synthetic resin. Each protrusion 22a is a member functioning as a stopper in the embodiment. The function of the protrusions 22a will be described later in detail.

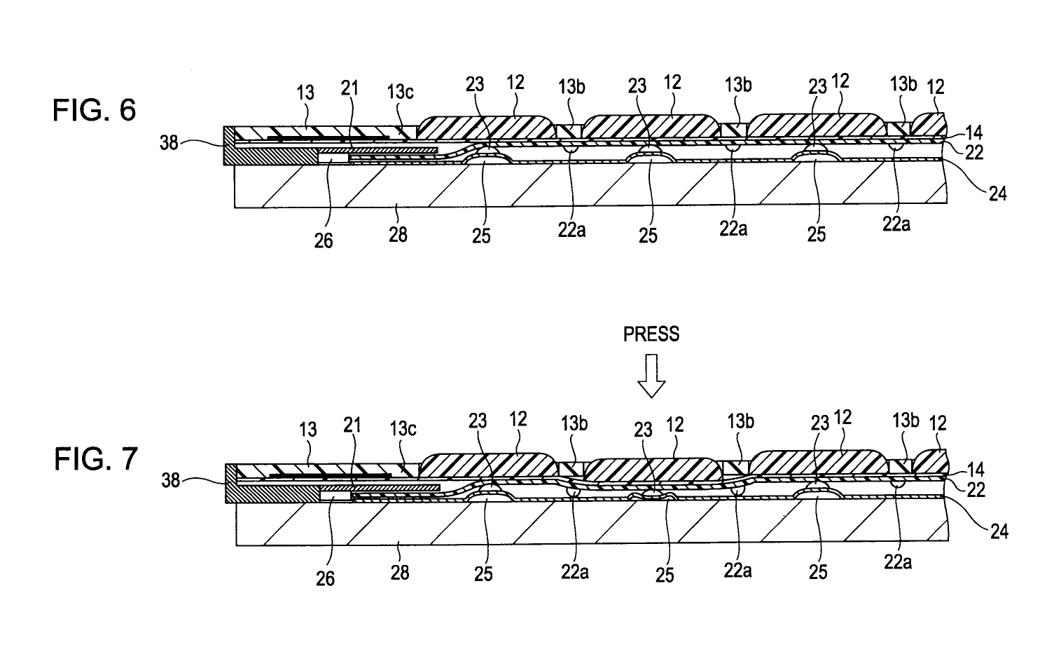

FIG. 6 is a partially cutaway sectional enlarged view along the line VI-VI of the key input device in which the plurality of elements shown in exploded view in FIG. 4 are integrated to each other.

In the embodiment shown in FIG. 6, in a normal state, a downwardly facing top portion of each protrusion 22a (provided at the lower surface of the light-guiding sheet 22) does not contact the front surface of the dome sheet 24, and is kept at a certain distance from the dome sheet 24. The height of each protrusion 22a may change due to various conditions. The embodiment does not eliminate a structure in which, in the normal state, an end of each protrusion 22a contacts the dome sheet 24.

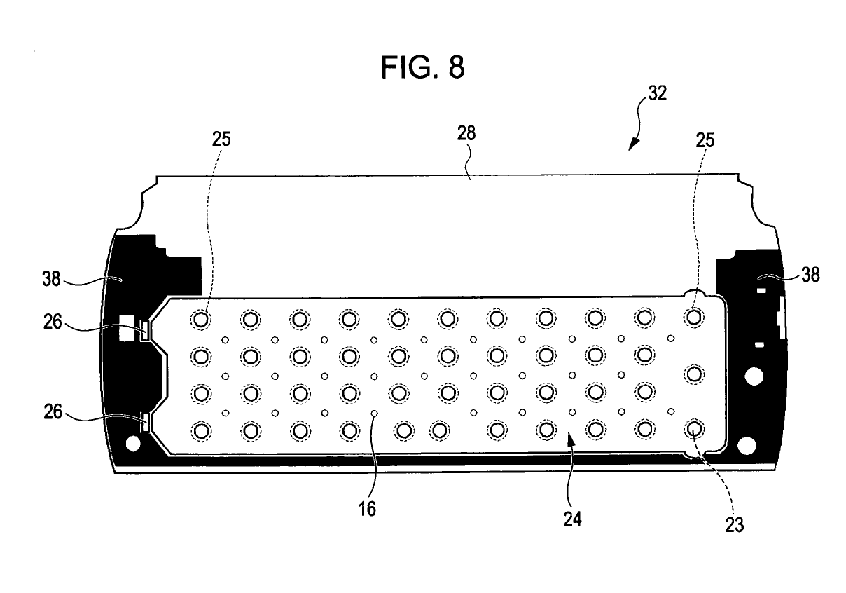

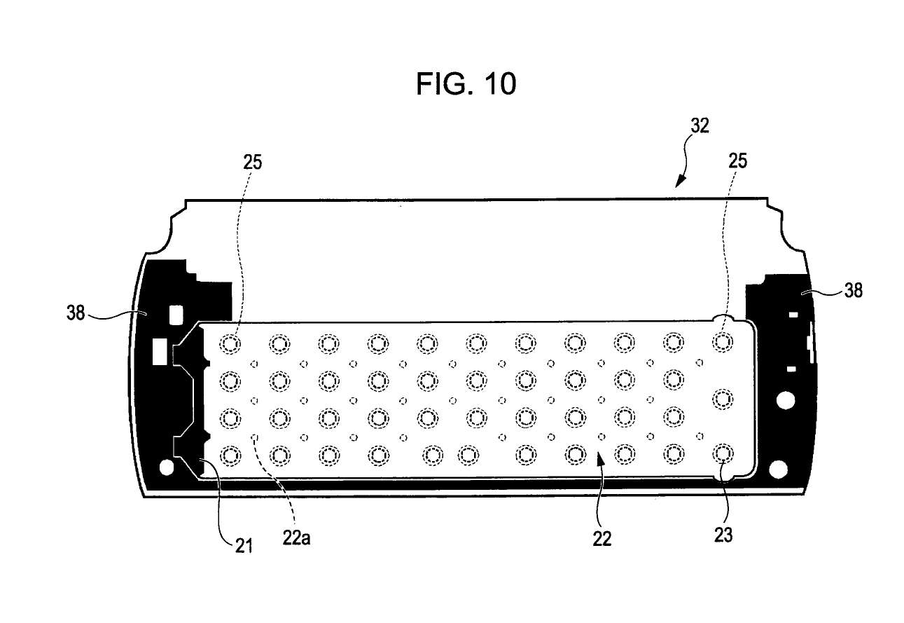

The LEDs 26, disposed at one end portion in a longitudinal direction of a terminal device, are disposed on the PCB 28 so as to oppose the one end portion so that light emitted from the LEDs 26 is incident upon an end portion of the light-guiding sheet 22. The light-shielding sheet 21 that covers the upper surfaces of the LEDs 26 is formed so that the light generated from the LEDs 26 does not leak upwards and so that light traveling upward is reflected and incident upon the end portion of the light-guiding sheet 22. A black frame 38 is disposed at a side of the LEDs 26 opposite to the light-guiding sheet 22. The entire shape of the frame 38 is shown in FIGS. 8 and 10 described later.

FIG. 7 is a sectional view showing a state in which one key top 12 corresponding to a portion of the sectional view of FIG. 6 is pressed. When a user presses any one of the key tops 12 with, for example, his/her finger tip, the key top 12 is moved downward along with a portion of the resilient sheet 14 that is situated therebelow, and the corresponding key dome 25 is pressed through the light-guiding sheet 22 and the corresponding protrusion 23. As a result, the key dome 25 is deformed so that its center portion is moved downward, and the center portion contacts the PCB 28. This causes the fixed contact (not shown) on the PCB 28 to be brought into electrical conduction, thereby turning on the key switch. At this time, in the areas 13b where the sides of the key tops 12 that are adjacent to each other oppose each other, the top cover 13 is not adhered to the resilient sheet 14. Therefore, as in FIG. 7, when the pressed key top 12 is moved downward, the portion of the resilient sheet 14 that is situated directly below the area 13b of the top cover 13 can separate from the top cover 13 and provide a stretching force.

Next, the function of each protrusion 22a provided at the lower surface of the light-guiding sheet 22 will be described. As described above, when a key top 12 is pressed and is moved downward, a portion of the resilient sheet 14 that is situated directly below the key top 12 is also moved downward. Here, when a protrusion 22a does not exist, a portion of the resilient sheet 14 that is situated directly below the key top 12 adjacent to the pressed key top 12 is also pulled downward. This may cause the adjacent key to operate accidently. Such an improper operation is called “in-response-to movement” of a key.

In contrast, each protrusion 22a (serving as a stopper) is provided between two movable contacts that are adjacent to each other, so as to prevent the resilient sheet from approaching within a predetermined distance with respect to a plane in which the fixed contacts are disposed when operating a key. The phase “between two movable contacts that are adjacent to each other” refers to at least one point on an imaginary boundary line (vertical line or a horizontal line) halfway between the movable contacts. It is not necessary for the one point to be situated at a position opposing a center point of opposing sides of the key tops, so that it may be situated at a position opposing end portions of the sides. During the operation of the key, after an end portion of the protrusion 22a has reached the front surface of the dome sheet 24, a portion of the resilient sheet 14 that is situated in correspondence with this position is prevented from moving further downward. By this, when one key top 12 is pressed, the pressing of the one key top 12 is prevented from influencing the adjacent key (that is, undergoing “in-response-to movement”) through the resilient sheet 14. As a result, even if a finger of the user is slightly displaced from the target key (key top), the target key is reliably operated.

In the key input device of the full key board in the small mobile terminal device shown in FIG. 1, the size of each key top 12 becomes inevitably small, and the key tops 12 are inevitably disposed close to each other. In such a background, if the user tries to press a key, and moves his/her finger towards the key top 12, the key top is hidden by his/her finger. Therefore, it is not necessarily easy to precisely press the center portion of the key top 12. In the embodiment, even if, in such a state, a position that is pressed by the finger is slightly displaced from the center portion of the key top 12 by a certain amount, the key can be reliably operated.

When such a partial adhesion structure is not used, the top cover 14 is adhered to the entire surface of the resilient sheet 13 up to the areas 13b adjacent to the sides of the key tops 12. Therefore, compared to the case in which the partial adhesion structure is used, it may be thought that the downward movement of a pressed key top 12 increases a pulling force on an adjacent key top 12. Therefore, it may be assumed that, when the protrusions 22a do not exist, the influence on adjacent keys is large in the partial adhesion structure. From this, it is assumed that the partial adhesion structure reduces the effect that a pressing operation of an operation key has on an adjacent key.

In cross section along a line (not shown) that is orthogonal to the line IIIB-IIIB shown in FIG. 3A and that passes through the center of each key top, what is described with reference to FIG. 7 is also applied as it is, except that the illustrated widths of the key tops differ.

When the finger of the user is moved off the key top 12, the key dome 25 is restored to its original state by its elastic force, so that the key top 12 returns to its original position.

FIG. 8 is a plan view showing a state in which the key domes 25, the dome sheet 24, and the LEDs 26 are mounted on the PCB 28 in the lower housing 32. Although not illustrated, for example, fine protrusions and recesses are formed with laser on the front surface of the dome sheet 24. The fine protrusions and recesses are formed for preventing improper illumination caused by adhesion of the light-guiding sheet 22 (in particular, a urethane sheet-like member). In addition, making the surface of the dome sheet 24 white and forming the fine protrusions and recesses of the dome sheet 24 are effective in diffusing the light from the LEDs 26 and causing the light to travel uniformly in the light-guiding sheet 22.

Although, for example, other electronic components are mounted on the PCB 28, they are not directly related to the present embodiment. Therefore, they will not be described below.

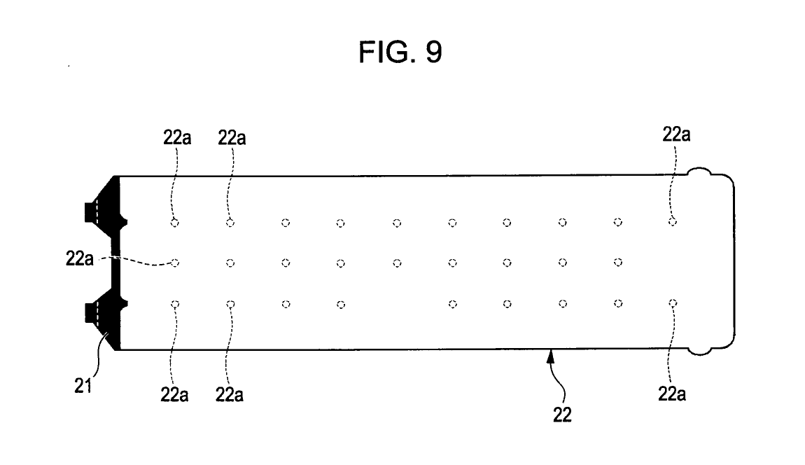

FIG. 9 is a top plan view of the light-guiding sheet 22 having the light-shielding sheet 21. The protrusions 22a are disposed at the lower surface of the light-guiding sheet 22. In the embodiment, the shape of the light-guiding sheet 22 is substantially the same as the external shape of the dome sheet 24 shown in FIG. 8. The end portion of the light-guiding sheet 22 opposing the LEDs 26 is shown with broken lines. The light-shielding sheet 21 covers the LEDs 26 and an end portion of the dome sheet 24 opposing the LEDs 26.

FIG. 10 is a plan view showing a state in which the light-guiding sheet 22 having the light-shielding sheet 21 is mounted by placing it on the dome sheet 24 at the lower housing 32 in the state shown in FIG. 8. The above-described key sheet 11 is further adhered onto the resulting structure. The key sheet 11 may be adhered by applying an adhesive to necessary locations of the back surface of the key sheet 11.

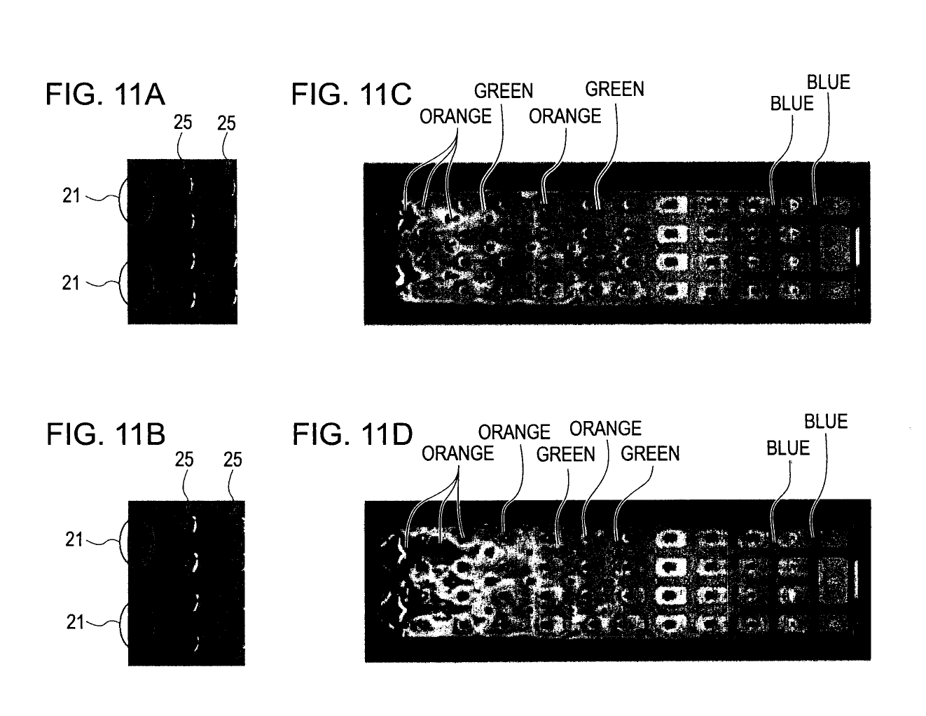

FIGS. 11A and 11B are back views of the light-shielding sheet 21 placed upon and adhered to a portion of the dome sheet 24, as seen from the LED side. FIGS. 11A and 11B show states in which the colors of the back surface of the light-shielding sheet 21, that is, the LED-25-side of the light-shielding sheet 21 are white and silver, respectively. FIGS. 11C and 11D show results of measurements of distributions of brightnesses at the upper surface of the light-guiding sheet 22 having the light-shielding sheet 21 in the cases shown in FIGS. 11A and 11B, respectively. The originals of FIGS. 11C and 11D are color figures. For convenience, however, FIGS. 11C and 11D show grayscale images. In FIGS. 11C and 11D, gray density portions labeled “orange” are the brightest portions; gray density portions labeled “blue” are the darkest portions; and gray density portions labeled “green” are portions of intermediate brightness.

In FIGS. 11C and 11D, the closer to the LEDs 26 (towards the left), the brighter, and the further away from the LEDs 26, the darker. When the case in which the back surface of the light-shielding sheet 21 is white (FIG. 11C) and the case in which the back surface of the light-shielding sheet 21 is silver (FIG. 11D) are compared with each other, it is confirmed that a brightness balance in the longitudinal direction (left-right direction in FIGS. 11C and 11D) of the mobile terminal device is better when the back surface of the light-shielding sheet 21 is white than when it is silver. When the back surface of the light-shielding sheet 21 is silver, it is confirmed that a side close to the LEDs is too bright, and that brightness balance in the longitudinal direction is poor.

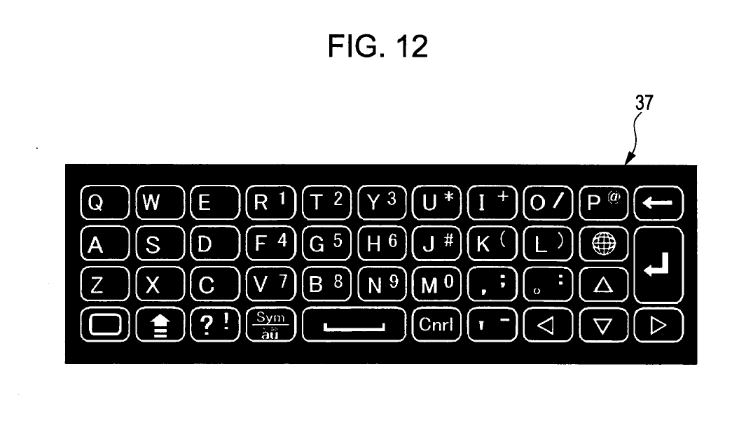

FIG. 12 is a plan view showing a state when the key input device is illuminated in the case where the light-shielding sheet 21 whose back surface is white is used. When this illumination is performed in a dark surrounding environment, edges of the respective key tops and the characters allotted to the respective keys are seen as standing out. Differences between the brightnesses in the longitudinal direction are reduced by diffusing light in a light path along the light-guiding sheet 22.

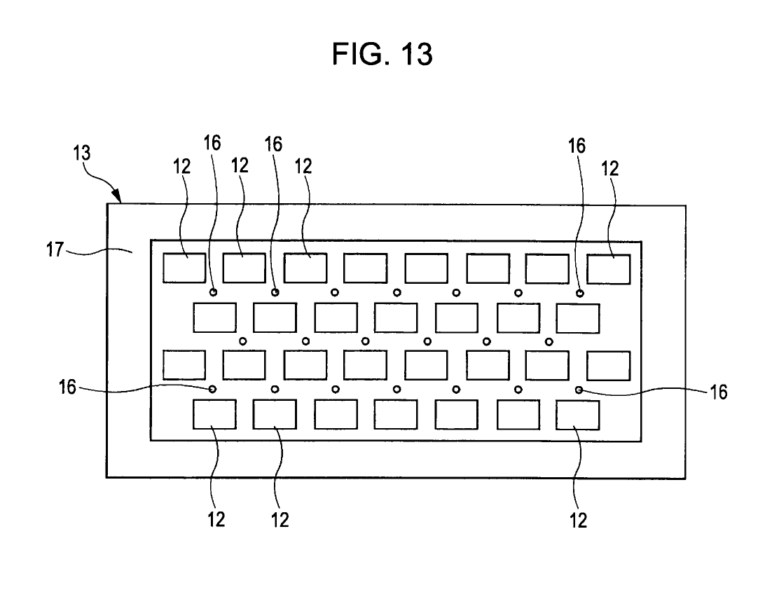

In the above-described embodiment, the key tops 12 are disposed in rows so as to be aligned both vertically and horizontally. Instead, as shown in FIG. 13, the key tops 12 may be disposed in rows so as not to be aligned vertically (or horizontally). In this case, as shown in FIG. 13, the spot areas 16 are obliquely upwardly provided in the areas between the adjacent key tops 12. The spot areas 16 correspond to the adhesion positions of the partial adhesion structure, and are situated where the protrusions (or posts) 22a for preventing “in-response-to movement” are provided. In this case also, each spot position 16 is disposed at least one point on the imaginary boundary line between two adjacent movable contacts.

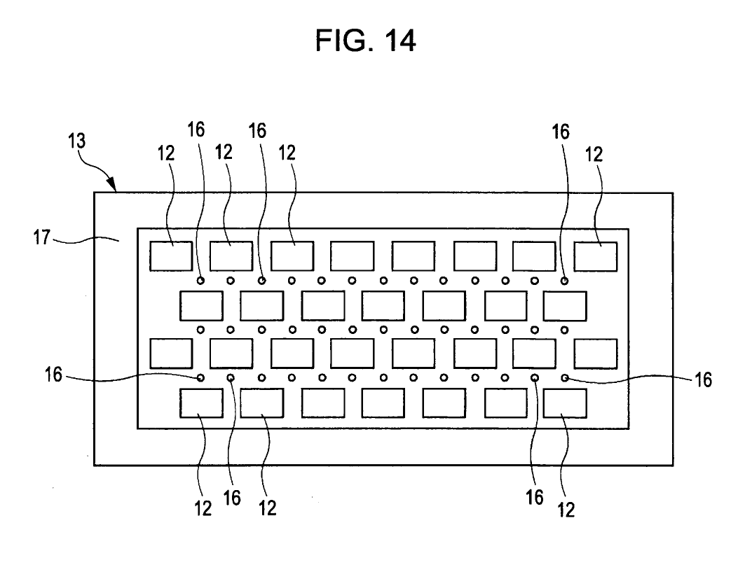

FIG. 14 shows another example in which the spot areas 16 are differently arranged when the key tops 12 are arranged as in FIG. 13. Compared to the example shown in FIG. 13, in FIG. 14, the number of spot areas 16 is increased. In this case also, each spot area 16 is disposed at least one point on the imaginary boundary line between two adjacent movable contacts.

Although preferred embodiments are described, various modifications and changes other than those mentioned above can be made without departing from the scope of the claims.

For example, the various dimensions, such as specific thicknesses and sizes, shapes, materials, structural features, etc. of the various elements mentioned above are merely specific examples. Accordingly, the claims are not limited thereto.

Although the number and positions of the spot areas 16 of the partial adhesion structure are the same as those of the protrusions 22a, it is not necessary for them to be the same.

Although the protrusions 22a (serving as stoppers) are provided at the lower surface of the light-guiding sheet 22, they may be provided at the upper surface of the dome sheet 24. In this case, each protrusion 22a is disposed between two adjacent fixed contacts.

Although the full keyboard is only described, the embodiments are not limited to the full keyboard. The present specification is applicable to any key arrangement in which a plurality of keys are disposed adjacent to each other. The present specification is also applicable to, for example, a numeric keypad input device.

What is claimed is:

1. A key input device comprising:
a keyboard which includes a plurality of key switches including at least two adjacent key switches; and
a stopper disposed between the two adjacent key switches and configured to inhibit one of the at least two adjacent key switches from receiving a pressing force when the other of the at least two adjacent key switches is pressed by a user.

2. The key input device according to claim 1, further comprising:
a resilient sheet having resiliency;
a plurality of key tops corresponding respectively to the plurality of key switches and fixedly disposed on the resilient sheet;
a plurality of movable contacts disposed below the plurality of key tops,
wherein the plurality of key switches are a plurality of fixed contacts disposed to oppose the plurality of movable contacts respectively, and the key switches operate in accordance with pressing operations of the plurality of key tops.

3. The key input device according to claim 2, wherein the stopper is configured to prevent the resilient sheet from approaching within a predetermined distance with respect to a plane in which the at least two adjacent key switches are disposed, at least one point on an imaginary boundary line between the two adjacent movable contacts.

4. The key input device according to claim 3, wherein the plurality of key tops are disposed in rows, and wherein the stopper is disposed at substantially a center portion of an area where corners of four of the plurality of key tops oppose each other.

5. The key input device according to claim 4, further comprising a light-guiding sheet disposed between the resilient sheet and the plurality of movable contacts, and a light-emitting element that leads light into the light-guiding sheet,
wherein the stopper is formed by a protrusion provided at a lower surface of the light-guiding sheet.

6. The key input device according to claim 5, wherein the light-emitting element is disposed at a position opposing an end portion of the light-guiding sheet,
wherein the key input device further includes a light-shielding sheet that covers an upper portion of the light-emitting element, and
wherein the light-shielding sheet prevents the light emitted from the light-emitting element from passing upward.

7. The key input device according to claim 1, further comprising a top cover having a plurality of openings from where the plurality of key tops are exposed,
wherein each of the plurality of key tops has a substantially square shape, and
wherein, while the plurality of key tops are exposed from the plurality of openings, the top cover is adhered to the resilient sheet excluding at least an area where sides of the key tops that are adjacent to each other oppose each other.

8. The key input device according to claim 7, wherein the plurality of key tops are disposed in rows, and
wherein the top cover is adhered to the resilient sheet at an area surrounding an area where the plurality of key tops are disposed in rows and at a substantially central portion of an area where corners of four keys in the area where the plurality of key tops are disposed in rows oppose each other.

9. The key input device according to claim 1, further comprising a contact cover sheet that covers the movable contacts as a result of positioning the movable contacts to positions corresponding to the respective fixed contacts at a printed circuit board where the fixed contacts are provided.

10. The key input device according to claim 9, wherein a surface of the contact cover sheet is provided with actuator members in correspondence with positions of the movable contacts, the actuator members transferring the pressing operations of the key tops to the movable contacts.

11. A mobile terminal device comprising:
a display unit; and
a key input device,
wherein the key input device includes
a keyboard which includes a plurality of key switches including at least two adjacent key switches, and
a stopper disposed between the two adjacent key switches and configured to inhibit one of the at least two adjacent key switches from receiving a pressing force when the other of the at least two adjacent key switches is pressed by a user.

12. The mobile terminal device according to claim 11, further comprising:
an upper housing which includes the display unit; and
a lower housing which includes the key input unit, the lower housing being connected to the upper housing and configured to move under and move out from under the upper housing by sliding the lower housing under the upper housing.
